(19) United States
(12) Patent Application Publication
(10) Pub. No.: US 2022/0070675 A1
(43) Pub. Date: Mar. 3, 2022

(54) System for the Transmission of Personal Data

(71) Applicant: Dirk Bohnes, Jupiter, FL (US)

(72) Inventors: Dirk Bohnes, Jupiter, FL (US); Jack Bohnes, Jupiter, FL (US)

(21) Appl. No.: 17/413,830

(22) PCT Filed: Dec. 20, 2019
(86) PCT No.: PCT/EP2019/086623

§ 371 Date: Jun. 14, 2021

(30) Foreign Application Priority Data
Dec. 21, 2018 (DE) 10 2018 222 752.7

(51) Int. Cl. H04W 12/50; H04W 4/80; H04W 4/02; H04W 12/63; H04L 29/08

(52) U.S. Cl. CPC H04W 12/50; H04W 4/80; H04L 67/306; H04W 12/63; H04W 4/023

(57) ABSTRACT

A system for forwarding personal data, including a first device with a radio module for wireless data transmission. The system also includes a second device having a second radio module for wireless data transmission which is suitable for exchanging data with the first device. An initialization is requested by the first radio module and/or by the second radio module and is received by the other radio module for initialization of a connection between the first device and the second device. In the event of an initialized connection, the first device is designed to transmit personal data directly by means of the first radio module to the radio module of the second device. The personal data are then compared on the second device, and an indication is generated in the event that a predefined criterion is satisfied.

### CROSS-REFERENCE TO RELATED APPLICATIONS

This application is the United States national phase of International Application No. PCT/EP2019/086623 filed Dec. 20, 2019, and claims priority to German Patent Application No. 102018222752.7 filed Dec. 21, 2018, the disclosures of which are hereby incorporated by reference in their entirety.

### BACKGROUND OF THE DISCLOSURE

### Field of the Disclosure

The disclosure relates to a system for the transmission of personal data, in particular for establishing contacts between two or more persons.

Within the framework of e-commerce it is required to establish contacts between persons who have previously not known each other. However, for keeping the number of potential contacts as small as possible it is required to previously exchange personal data, such as interests, an agreement on an object of purchase or a target price.

### Description of Related Art

Furthermore, today's dating applications require an exchange of personal data, such as interests and dispositions, for selecting a suitable dating partner. However, this does not only apply to data file applications but also to any establishing of contacts between persons who have previously been strangers or unknown to each other within the framework of the data file application, for example, but also to any other contact exchange or application for establishing contacts between persons who share common or the same interests or pursue the same intentions. In the following, the term “common interests” is selected for all these applications, where this term must not be understood as limiting but generally refers to persons between whom contacts are to be established.

In usual applications, this exchange of information is performed via a server through which the comparison between the parties to be brought in contact with each other is performed. Here, it is required to send one's own private information worthy of protection via data communication links and thus to reveal it at least to the operator of the server. Thus there is a high potential of misuse by intercepting the personal information, unauthorized retrieving of the personal information from the server, further use of the personal information by the server operator and the like, for example.

Furthermore, there is the risk of misuse by means of a nonexistent identity (“fake identity”). Due to the anonymity of dislocated distributed applications the respective user cannot easily determine whether the given identity belongs to a real person.

### SUMMARY OF THE DISCLOSURE

It is an object of the present disclosure to provide a system for the transmission of personal data, in particular for establishing contacts between two or more persons, offering a better data security of the personal data.

This object is achieved by a system according to claim 1 as well as a method for operating the system according to claim 13.

The system for the transmission of personal data according to the disclosure includes a first device having a first radio module for wireless data transmission. Furthermore, the system includes at least one second device having a second radio module for wireless data transmission, where the second radio module is suitable for exchanging data with the first device. Here, the first radio module and/or the second radio module are configured for sending an initialization which is received by the other radio module for initializing a wireless radio connection between the first device and the second device. Thus an initialization by the first radio module, an initialization by the second radio module or a common initialization by both the first radio module and the second radio module can be performed. In particular, the initialization is realized as a handshake for transmitting the relevant data transmission parameters between the first device and the second device. However, preferably the initialization includes general information less worthy of protection on the persons between whom a contact is to be established, for example the information “I am willing to sell” or “I am looking for persons with common interests”. Also, the initialization can contain information of whether at the present time sales information or information on the respective interests is to be sent to the user of the first device and/or the second device. However, it is also possible that the initialization already contains personal data which are provided in an encrypted manner. The decryption can only be performed by devices of the system using a common key or other known encryption algorithms. In particular, a private key exists on the first device, a common public key and a private key exist on the second device, where encryption is preformed on the first device by means of the private key of the first device and the public key, and encryption is possible only when the private key of the second device is known.

According to the disclosure, in the case of an initialized connection, the first device is configured such that the first radio module directly sends the personal data to the second radio module of the second device. The first and/or the second radio module are in particular configured for receiving the personal data from the respective other device. In particular, in the case of an initialized connection, at least one second device is also configured such that the second radio module directly sends the personal data to the first radio module of the first device. If personal data are transmitted from the first device to the second device, the personal data are compared on the second device, where an indication is generated when a predefined criterion is satisfied. Alternatively or additionally, the transmitted personal data are compared on the first device if personal data have been transmitted from the second device to the first device. Here, the criterion can be a purchase price or the restriction with regard to an object of purchase, for example. Furthermore, the criterion can be an adequate matching of interests, dispositions and preferences of the persons between whom a contact is to be established such that it can be assumed that the respective other person is a person sharing common interests. If thus the predefined criterion is satisfied or an adequate matching exists, the indication is generated in particular by means of the first device and/or the second device. Furthermore, the users may wish to obtain information on a certain subject, advertisements, offers or the like. Due to the direct transmission of the personal data between the first device and the second device it is no longer required to exchange personal information worthy of protection with a server via the internet, whereby an undesired disclosure of the personal data is reduced. In addition, the comparison of the personal data is directly performed on the first device and/or the second device such that no server is required for this purpose either. Thereby, the risk of the personal data being unintentionally or intentionally further used by an operator of the server is reduced. Since a direct transmission between the devices of the system is performed, a system is created which is dislocated to a smaller extent than in the case of server-based applications for establishing contacts between persons sharing common interests. The users of the system can thus more rapidly and easily determine whether the person sharing common interests is a real person or a fake identity. At the same time, the direct transmission of the personal data allows for saving power in the individual devices since no server-based transmission takes place.

Alternatively, the personal data refer to the position of a user. Here, first an initialization between the first device and the second device is performed. Then data are exchanged in predefined time intervals. For example, the first device is a device which is removably attached to a person. The second device is at a stationary position. The criterion is the loss of connection between the first device and the second device. If even after elapse of the predefined time interval no data are exchanged between the first device and the second device, the criterion is satisfied and an indication is generated. For example, the person can be a dementia patient, where the second device is arranged in his/her flat or house. If the person leaves a predefined area such that data are no longer exchanged between the first device and the second device, an indication is triggered, where in particular the indication is forwarded to nursing staff and/or family members and/or relatives and/or neighbors and/or residents or the like. Thus personal data, for example the position of the person, are not forwarded unless this is required. In particular, the transmitted data are vital signs, for example pulse, temperature, capturing of movement, oxygen saturation in the blood, insulin or glucose value of the blood or the like.

Preferably, the public key and the private key of the first device are generated on the basis of the personal data. Thus a comparison of the personal data can be performed on the basis of the thus generated key, where an identification of the user is possible only when a decryption by means of the private key of the second device is possible, where the second key, in turn, is generated on the basis of the personal data of the user of the at least one second device. The criterion to be satisfied is thus the ability to decrypt the transmitted data by means of the private key of the second device, whereby the identification of the participating persons sharing common interests is enabled. Thus, although the personal data are visible, they cannot be assigned to any person, whereby the privacy remains protected.

Preferably, when the connection is initialized, personal data are also directly sent by means of the second radio module of the at least one second device to the first radio module of the first device. Then a comparison of the personal data is also performed on the first device, and only when a predefined criterion of both the first and the at least one second device is satisfied, an indication is generated. If a plurality of second devices is provided, a comparison of the personal data is in particular performed on each of these second devices. Thus a comparison of the personal data is performed on both and/or all devices such that on both and/or all devices the information is available as to whether there is an adequate match such that, accordingly, an indication can be generated. Thus no server-based data transmission is necessary which would require an access point to a wireless communication network. Thus a simple infrastructure is created which exchanges personal data in an energy-saving manner and finds matches.

Preferably, a third device is provided which is in particular of a stationary configuration or is arranged stationarily. In particular, the third device serves as a host, where the third device includes a third radio module for wireless data transmission, where the third radio module is suitable and configured for exchanging data with the second and/or the first device. Here, the first radio module is configured for sending an initialization which is received by the third radio module and forwarded to the second radio module of the second device for initializing a wireless radio connection between the first device and the second device. Furthermore, an initialization can be sent from the second radio module of the second device, as described above, and be forwarded to the first device via the third device. Thus an initialization by the first radio module, an initialization by the second radio module or a common initialization by both the first radio module and the second radio module can be performed, where always the wireless communication link between the first device and the second device is realized via the third device serving as a host.

Preferably, in the case of a suitable initialization of the wireless radio connection, all of the first and/or the second devices are adapted to be connected to each other by means of the third device serving as a host.

In particular, the third device does not have any internet connection, no wireless telecommunication connection (such as GSM, 3G, 4G, 5G or the like) or any connectivity beyond the third radio module such that the first device and/or the second device together with the third device define a closed network for exchanging personal data. Thereby, the data security is increased.

Preferably, more than one second device are provided, where the initialization is received and/or sent by all second devices. In particular, in the case of an initialized connection between the first device and the plurality of second devices, a direct transmission of the personal data is then performed, in particular via the third device. Here, the first device and/or each of the second devices are configured for performing a comparison of the personal data and generating an indication when a predefined criterion is satisfied. If more than one device satisfy the criterion, an automatic or manual selection of that device can be performed that is designed to generate the indication. It is particularly preferred that that second device can be selected that best satisfies the criterion, for example when as many matches as possible exist or the like. Alternatively, the second device offering the highest price etc. can also be selected.

Preferably, the first device and at least one and preferably all second devices are of an identical configuration such that the one device can both be used as the first device according to the invention and one of the second devices according to the invention.

Preferably, the first device and/or at least one and in particular all second devices includes a memory module, where the memory module is configured for storing rejected initializations and then, at least over a predefined period of time in which the rejected initializations are stored, directly reject another initialization request. Here, the predefined period of time can be a minute, an hour, a day or the like, or the predefined period of time extends up to a modification of the personal data on the same device. If the interests or the like are adapted, for example, previously rejected initializations are deleted from the memory device for enabling these devices to perform another initialization.

Preferably, the personal data are not transferred to the second device via a base station of a mobile radio communication system, for example eNB (Evolved Node B), a server or a core net (EPC—Evolved Packed Core) of a mobile radio communication system. Alternatively or additionally, the transfer of personal data does not take place via an access point of a WLAN architecture. Here, forwarding of personal data exclusively takes place in a point-to-point connection between the first device and the second device such that no other portion of the data transmission infrastructure has access to the personal data. This offers the advantage that no radio connection to any external infrastructure is required and thus the system can also be used in enclosed rooms or the like. Alternatively, in particular when a third device is provided, an initialization can be realized via the third device and then a data exchange between the first device and one of the second devices is performed through a point-to-point connection or also via the third device serving as a host.

Preferably, the wireless data transmission is effected via an NFC connection (Near Field Communication), a Bluetooth connection in particular of the fifth generation, a ZigBee connection, an ultra-wide band connection (UWB—Ultra-WideBand) or a CSS connection (Chirp Spread Spectrum). Generally, the wireless data transmission is a wireless data transmission via WPAN (Wireless Personal Area Network).

Preferably, the first device sends the initialization via Broadcast. Thus the initialization can be received by a plurality of further devices, where merely such connections are initialized where a direct wireless data transmission can be performed. For example, the initialization is a Bluetooth initialization which is sent via Broadcast. The Bluetooth connection of the first device can however only be realized with a second device which is also configured in accordance with the present system. Furthermore, a connection as described above is in particular realized only when the preconditions possibly contained in the initialization are met.

Preferably, the first device includes a position module for determining the position of the first device. Alternatively or additionally, the second device includes a position module for determining the position of the second device, where the first device and/or the second device are configured for transferring the respective position to a common server. This is in particular effected by means of a respective further radio module. Here, the initialization between the first device and the second device is performed only when they are located at a predefined distance to each other. In particular, this distance is smaller than 100 meters and particularly preferably smaller than 30 meters. Thus, although the position of the first device and/or the second device is transmitted to a server, the exchange of personal data continues to be performed between the devices such that no personal data, except for the respective position, are transferred to the server. Thereby, it is no longer required to send the initialization via Broadcast but the initialization can be specifically sent and addressed to the second device which is located at the predefined distance.

Preferably, the first device includes an optical and/or acoustical and/or haptic indicating element for issuing the generated indication. In particular when the indicating element is configured as an optical element, the latter is not adapted to be covered and/or includes a sensor for detecting a covering. Thus it is not possible to suppress a generated indication and hence obtain the personal data of the respective other one by purposefully retrieving the criteria. Alternatively, a covering detected by the sensor is interpreted as a rejection of the establishment of a contact.

Preferably, the first device and/or the at least one or all second devices include a memory module, where the generated indication is saved in the memory module for later retrieval in the case of an incomplete initialization between the first device and the respective second device, or if during the initialization the first device or the respective second device indicates that a generation of the indication is currently not possible. For example, if the user of a device is in a situation or an environment where an indication is not desired, this is transmitted to the respective other devices within the framework of the initialization. Alternatively or additionally, the generated indication is stored in a memory module of the first device and can then be retrieved by the user at a later time. Alternatively or additionally, the indication is transmitted to a smartphone, another device or another mobile terminal, to an e-mail address, a server or the like.

Preferably, the first device and/or the second device are a mobile terminal, for example a mobile phone, a laptop, a tablet, a smartphone, a wearable, for instance a smartwatch, a smart wristband and the like. However, preferably the first device and or the second device are a separate beacon whose function is limited to the functionality of the system described above. In particular, the beacon is not a mobile phone, laptop, tablet, smartphone or the like having further connectivity possibilities. In particular when the first and/or the second device are configured as a beacon, they exclusively include a single radio module for direct transmission of personal data to the respective other device. Thus the radio module is of course also configured for receiving the personal data of another device.

Preferably, the indicating element is configured as a separate indicating element which is separated from the first device and/or the second device. For example, if the first device is a terminal, the indicating element configured as a separate indicating device can be a normal flashing light which is connected in the usual manner to the terminal via Bluetooth. If thus a match exists and if an indication is generated, the terminal sends a corresponding signal to the separate indicating device which then generates the indication as a haptic and/or optical and/or acoustical indication.

Preferably, the first and/or at least one second device includes a processor at least for performing the comparison of the personal data. Here, the radio module and/or memory module can be connected to the processor. Further functions can also be provided by the processor.

Furthermore, the present invention relates to a method for operating a system described above.

Furthermore, the invention relates to a device having a processor and a memory, where a program is stored in the memory and can be executed on the processor for performing the method for operating the device described above, in particular the initialization of a connection to at least one further device, exchange of personal data, comparison of the personal data and check for satisfying a criterion and generation of an indication when the criterion is satisfied. Furthermore, the device can be further developed in accordance with the features of the system described above.

### BRIEF DESCRIPTION OF THE DRAWINGS

Hereunder the disclosure will be explained in detail on the basis of preferred embodiments with reference to the accompanying drawings in which:

FIG. 1 shows a schematic view of the system according to the invention,

FIG. 2 shows a flow chart of the method according to the invention, and

FIG. 3 shows an embodiment of a device according to the present invention.

### DETAILED DESCRIPTION

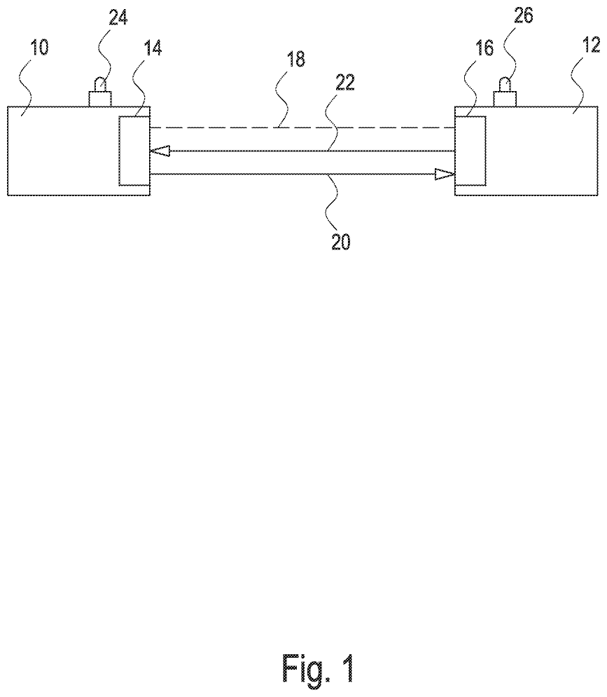

The system according to the invention shown in FIG. 1 includes a first device 10 as well as at least one second device 12. Here, the first device 10 includes a radio module 14 which is configured for wireless data transmission. Likewise, the second device 12 includes a second radio module 16 for wireless data transmission to the first device. Here, the wireless data transmission in particular includes both the transmission and the reception of personal data.

For establishing a connection between the first device 10 and the second device 12 the first device 10 and/or the second device 12 first send an initialization 18 which is received by the respective other device 10, 12 for establishing a connection that is suitable for a wireless transmission of personal data between the first device 10 and the second device 12. When the initialization has been performed, personal data are then directly exchanged between the first device 10 and the second device 12. For example, for this purpose the first device 10 transmits personal data to the second device 12 as shown by an arrow 20, which second device receives these personal data. Alternatively or additionally, personal data of the second device 12 are transmitted to the first device 10 as shown by an arrow 22, which first device receives the personal data. Then the personal data of the first device 10 and the second device 12 are compared. If personal data have been transmitted from the second device 12 to the first device 10, the comparison is performed by the first device 10. If personal data have been transmitted from the first device 10 to the second device 12, the comparison is performed by the second device 12. Likewise, a comparison of the personal data can be performed by both the first device and the second device. If the comparison shows that a predefined criterion has been satisfied, for example an adequate match of the dispositions and interests of the users of the first device 10 and the second device 12 exists, an indication is generated by means of an optical indicating device 24 of the first device 10 and/or an optical indicating device 26 of the second device 12, for example.

The personal data are a purchase interest or a purchase price, for example, if the system is used for establishing a contact between a seller and a purchaser.

Alternatively, the personal data are personal dispositions and interests of the respective users of the devices used for selecting a person sharing common interests. These may be sexual preferences, one's own age, desired age of a person sharing common interests, one's own looks, desired looks of the person sharing common interests, one's own hobbies and interests as well as desired hobbies and interests of the person sharing common interests etc., for example. On the basis of these personal data a suitable person sharing common interests is then determined by comparison, where, in this case, the predefined criterion to be satisfied is as large an overlap or match as possible of the respective requirements. Furthermore, individual requirements can be marked as necessary, for example the sexual preference and/or the age.

On the other hand, the further requirements such as hobbies and interests, for example, can be prioritized such that a suitable selection of a person sharing common interests can be made.

In the illustrated example, the system includes only one second device. However, the invention is not limited thereto such that a plurality of second devices can be provided. If in the plurality of second devices the criterion is satisfied (where in all second devices the criterion can be the same or a different one and is predefined in an individualized manner), an indication is generated by all second devices. Alternatively, a selection on the basis of the degree of matching of the interests, a manual selection or a random selection is made.

Alternatively, for this purpose, necessary requirements can be checked for matching within the framework of the initialization such that in the case of lack of matching of these requirements no further connection between the first device and the second device is established and no further personal data are transmitted.

If the criterion is satisfied and if in particular the respective other user is a suitable person sharing common interests, the respective indication devices 24, 26 generate an indication. In particular, this cannot be covered such that the indication is clearly visible or audible to the respective other user. Alternatively, the indicating device is adapted to be covered, for example by the hand of the user. The covering is detected by means of sensors 34 and can be interpreted as a rejection of establishment of a contact, for example. The indication enables the user of the first device and the user of the second device 12 to identify themselves and thus get together. For example, here the optical indication can have the same color, the same flashing sequence or color sequence for ensuring a unique identification even in an environment where a plurality of devices is provided that may possibly also generate an indication.

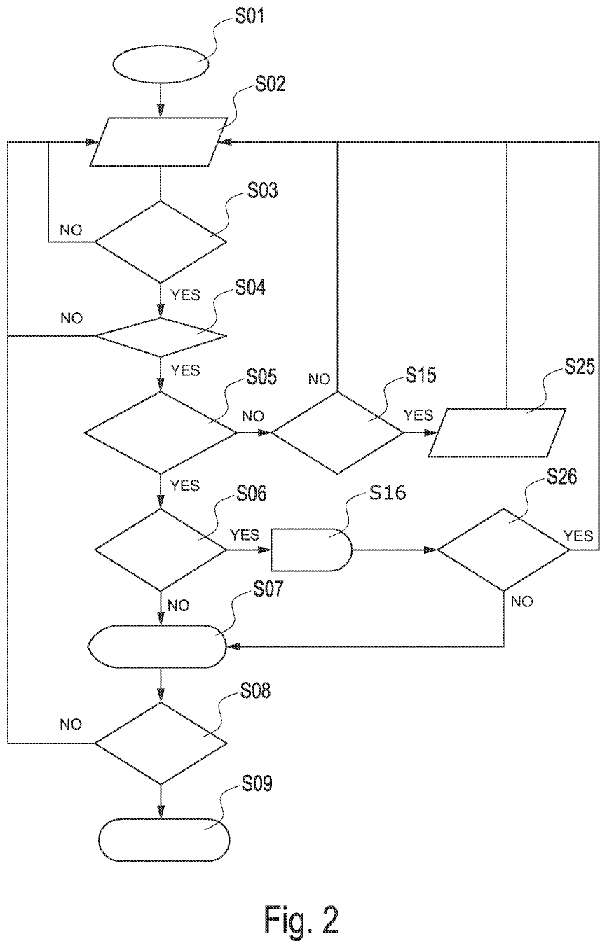

FIG. 2 shows the sequence of the method according to the disclosure. After the start S01 the first device 10 broadcasts an initialization 18 S02. Then it is checked whether the initialization has been received by another device S03. If the initialization has not been received by another device, another broadcasting of the initialization as per step S02 is performed at a later date. However, if the initialization has been received by another device and a connection is established between the first device 10 and the second device 12, the transmitted personal data are compared S04. If a predefined criterion, such as a required match between the specified requirements, is not satisfied, the method is started again with broadcasting the initialization as per step S02.

However, if the predefined criterion is satisfied, it is in particular checked whether the user of the respective other device is willing to establish a contact S05. If such establishment of contact is currently not desired, a message can be deposited in the other device S15. If such a message is not desired, the method starts again with an initialization as per step S02. If such a message is desired, it is in particular preferably deposited in a memory module of the device of that party that is not willing to establish a contact at time being S25.

However, if both users are willing to establish a contact, an indication is generated S07. However, first it is in particular checked whether the indicating device 24, 26 is covered S06. If the indicating device 24, 26 is covered, it is waited for a predefined period of time S16 and then it is checked again if the indicating device 24, 26 is covered S26. If the indicating device 24, 26 is still covered, the method is stated again with broadcasting the initialization as per step S02 or it is waited again for a period of time. If, however, the indicating device 24, 26 is not covered after the predefined period of time S16, an optical indication is generated as per S07. The check as to whether the indicating device 24, 26 is covered can be performed by a proximity sensor, for example, which is arranged directly beside or in the vicinity of the indicating device 24 and 26, respectively. However, the steps S06, S26 for checking whether the indicating device 24, 26 is covered can be omitted, in particular if the indication is an acoustical indication.

On the basis of the generated indication, which in the case of an optical indication has the same color, the same flashing sequence or the same color sequence, or in the case of an acoustical signal has an identical melody, for example, the users of the respective devices can identify themselves and get together. Then a contact is established between the users S08 who then decide whether the respective users are suitable persons sharing common interests and whether the method is to be terminated at this step and whether the person found is a suitable person sharing common interests S09. Otherwise the method is started again by sending a new initialization as per S02 for finding another person sharing common interests, such as a dating partner, for example.

S01 Start

S02 Initialization is broadcasted

S03 Initialization with another device successful?

S04 Predefined criterion satisfied?

S05 Willing to establish a contact?

S06 Is device covered?

S07 Generation of an indication

S08 Establishing a contact, suitable person sharing common interests?

S09 End

S15 Is a message to be deposited?

S25 Deposition of the message

S16 Waiting for a predefined period of time

S26 Device still covered?

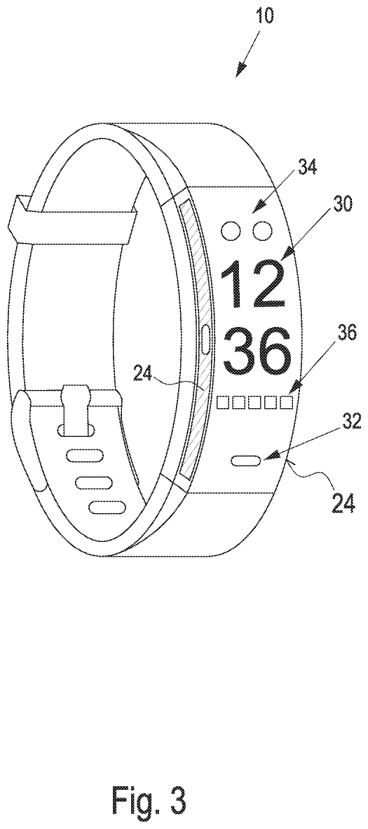

FIG. 3 shows an exemplary embodiment of a device according to the present invention configured as a wearable in the form of a smart wristband. Here, the device can include further functionalities. The device 10 includes a display 30 which is also configured for displaying the time, for example. Furthermore, the device 10 includes operating elements 32 for entering the information as to whether establishment of a contact is desired at the time being, for example. Furthermore, the device 10 includes two laterally arranged indicating devices 24 which are configured for generating an optical indication. In addition, the device 10 includes touch sensors or proximity sensors 34 for detecting whether the device 10 is covered for suppressing the indication. Furthermore, the display 30 can be configured for showing an indication 36 regarding satisfying of a predefined criterion. Hence the indication 36 can be illustrated as a full bar or as a complete number of symbols in the case of a complete overlap of the interests and dispositions, where a match to a smaller degree of the dispositions and interests are illustrated by the indication 36 as fewer symbols and not completely filled bar. Thereby, the user is directly informed of the degree of matching with regard to the person sharing common interests, such as a potential dating partner, for example.

Here, the system for forwarding personal data exchanges private data worthy of protection exclusively between the respective devices which have previously been initialized in a suitable manner. Thus private data for a comparison between the respective users are not disclosed, are not sent via the internet or transmitted to a server, whereby the data integrity is increased and data misuse is prevented. In particular upon termination of the method, the respective devices are designed to immediately delete the received personal data such that reading from the respective device is not possible.

1. A system for forwarding personal data, comprising:
a first device having a first radio module for wireless data transmission,
at least one second device having a second radio module for wireless data transmission and suitable for exchanging data with the first device,
wherein the first radio module and/or the second radio module send an initialization which is received by the other radio module for initializing a connection between the first device and the second device,
wherein, in the case of an initialized connection, the first device is configured for directly sending personal data to the second radio module of the second device by means of the first radio module,
wherein a comparison of the personal data is performed on the second device and, when a predefined criterion is satisfied, an indication is generated.

2. The system according to claim 1, wherein in the case of an initialized connection, personal data are also directly sent to the first radio module of the first device by means of the second radio module of the at least one second device, and a comparison of the personal data is also performed on the first device, and only if a predefined criterion is fulfilled, an indication is generated on both the first device and the second device.

3. The system according to claim 1, further comprising more than one second device is provided, wherein the initialization is received and/or sent by all second devices.

4. The system according to claim 1, further comprising a third device is provided which is in particularly stationarily configured, wherein the third device comprises a third radio module for wireless data transmission, wherein the third radio module is configured for exchanging data with the second and/or the first device, wherein the first and/or the second radio module are configured for sending an initialization which is received by the third radio module for forwarding it to the radio module of the respective other device for initializing a wireless radio connection between the first device and the second device.

5. The system according to claim 1, wherein the personal data is not transferred to the second device via a base station, server or a core network.

6. The system according to claim 1, wherein the wireless data transmission is NFC, Bluetooth, ZigBEE, CSS, UWB or WPAN.

7. The system according to claim 1, wherein the first device sends the initialization by Broadcast.

8. The system according to claim 1, wherein the first device comprises a position module for determining the position of the first device and/or the second device comprises a position module for determining the position of the second device, wherein the first device and/or the second device are configured for sending the respective position to a common server, wherein the initialization between the first device and the second device is performed only when they are located at a predetermined distance to each other.

9. The system according to claim 1, wherein the first device and/or the second device comprise an optical and/or acoustical and/or haptic indication element for issuing the generated indication.

10. The system according to claim 1, wherein the indication is in particular forwarded to a third terminal and in particular a separate indication device.

11. The system according to claim 1, wherein the first device and/or the second device comprise a memory module, wherein the generated indication is saved in the memory module for later retrieving.

12. The system according to claim 1, wherein the first device and/or one of the second devices are a mobile terminal.

13. A method for operating a system according to claim 1.

14. A device for transmitting personal data comprising a first radio module, wherein the first radio module is configured for sending or receiving an initialization such that a connection to at least one or a plurality of further device is established, wherein the first radio module is configured for receiving personal data when the connection is initialized, wherein a comparison of the received personal data is performed and an indication is generated when a predefined criterion is satisfied.
